(19) United States
(12) Patent Application Publication
(10) Pub. No.: US 2013/0223302 A1
(43) Pub. Date: Aug. 29, 2013

(54) MULTI-PROTOCOL SWITCHING CONTROL SYSTEM SUITABLE FOR CONTROLLING DIFFERENT ELECTRONIC DEVICES OF DIFFERENT PROTOCOLS

(71) Applicant: CHIEN-CHIH KUO, New Taipei City (TW)

(72) Inventor: CHIEN-CHIH KUO, New Taipei City (TW)

(21) Appl. No.: 13/403,953

(22) Filed: Feb. 23, 2012

(51) Int. Cl. H04B 7/00; H04W 4/00

(52) U.S. Cl. 370/310

(57) ABSTRACT

A multi-protocol switching control system suitable for controlling different electronic devices of different protocols by using a router capable of receiving different kinds of protocol to instruct switch sets connected thereto. The system comprises: a wireless router for controlling at least one switch set; the switch set receiving control signals from the central controller for turning on or off electronic devices connected thereto. A protocol area is defined in the router and includes at least two control protocols. The switch control unit defines a protocol assign function to the protocol area. The function causes that one can define or input a protocol to the protocol area and assign the protocol as an operating protocol of the system so that the operation protocols in the wireless routers are matched to those used in switch sets; thereby, the system can receive external instructions and instruct the switch sets to perfume predetermined operations.

### FIELD OF THE INVENTION

The present invention relates to automatic control, and in particular to a multi-protocol switching control system suitable for controlling different electronic devices of different protocols.

### BACKGROUND OF THE INVENTION

In the prior art, many remote control systems for controlling lamps have been developed. In these systems, lamps can be remotely controlled by remote controller. Also, many related patents are disclosed. However, these prior art has following problems. Firstly, the protocol of the switch for the device is dependent to the manufactures. The devices of different manufacturers have different protocols which are not compatible to each other. As a result, the lamp control system must be fitted to the lamps. If the manufacture of lamps to be controlled are different from that of the control system to be used, the lamps or the control system must be changed for causing the two to be matched to one another. Moreover, current lamp systems have dedicated remote controllers which are not compatible to one another, but as we know, handsets have become very popular electronic devices. Almost everybody has one or more handsets and in many field, handsets are used to many newly developed applications, even in control. If handsets can be used in operations, it will provide a great convenience to users.

### SUMMARY OF THE INVENTION

Accordingly, the object of the present invention is to provide a multi-protocol switching control system suitable for controlling different electronic devices of different protocols, wherein the central controller of the present invention could be built with various lamp control protocols so as to fit different lamps or different electronic devices of different manufacturers. Thus if a user desires to built the system of the present invention, he (or she) does not need to update the switch sets or the lamps (or electronic devices) connected to the switch sets. Furthermore, if the control protocol for controlling the device to be used is not originally built in the system, the control protocol can be downloaded through networks or other input device for suiting the electronic devices connected to the switch set. The operation is easy and convenient. Moreover, the present invention provides many different control interfaces, such as keys, computers, remote controllers, handsets, or far ends controller through networks, etc. The lamp operating schedule in the central controller can centrally control the devices automatically.

To achieve above object, the present invention provides a multi-protocol switching control system suitable for controlling different electronic devices of different protocols by using a router capable of receiving different kinds of protocol to instruct switch sets connected thereto, the control system comprising: a wireless router for controlling at least one switch set connected thereto by wired ways or wirelessly; the wireless router including a central controller and the central memory; the at least one switch set having one or more switches; the switch set receiving control signals from the central controller for turning on or off electronic devices connected thereto; wherein a protocol area is defined in the central memory by using a form of a firmware; the protocol area includes at least two control protocols; the switch control unit defines a protocol assign function to the protocol area; the function causes that one can define or input a protocol to the protocol area and assign the protocol as an operating protocol of the whole system so that the operation protocols in the wireless routers are matched to those used in the switch sets; thereby, the system can receive external instructions and instruct the switch sets connected to the central controller to perfume predetermined operations.

### BRIEF DESCRIPTION OF THE DRAWINGS

FIG. 1 is a schematic view showing the system structure of the present invention.

FIG. 2 is a schematic view showing the structure of the central controller of the present invention.

FIG. 3 is a schematic view showing the structure of the central controller of the present invention.

FIG. 4 is a schematic view showing the application of the present invention.

FIG. 5 shows the switch control unit of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

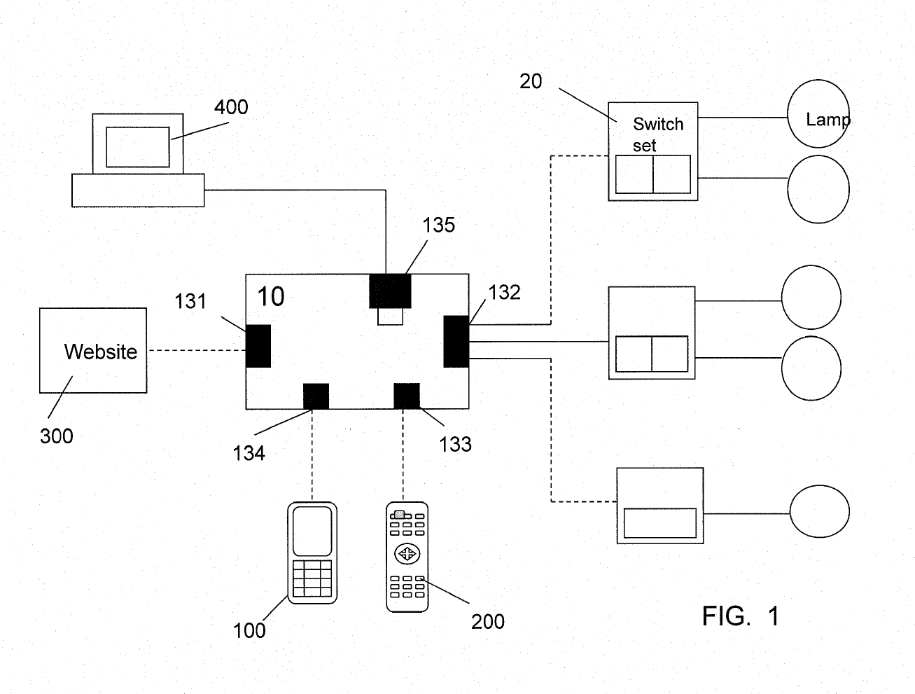

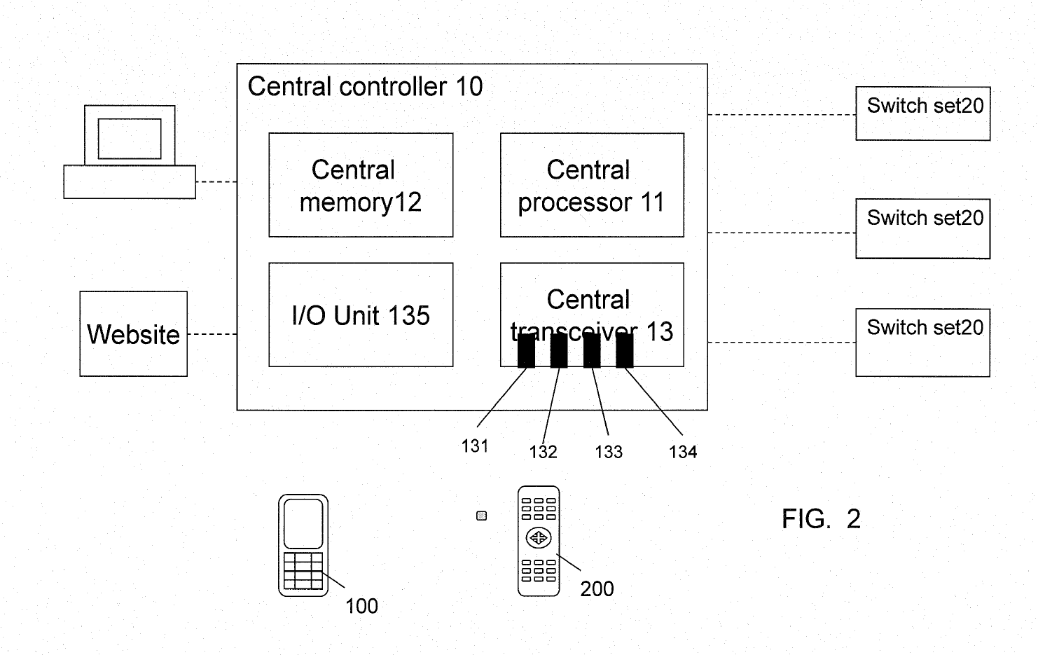

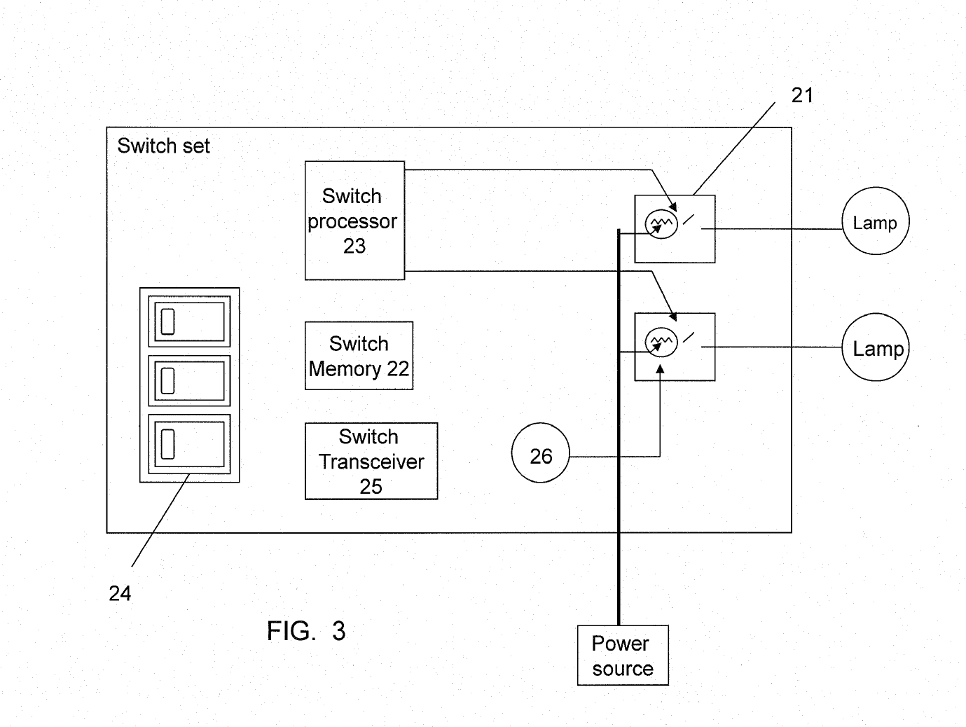

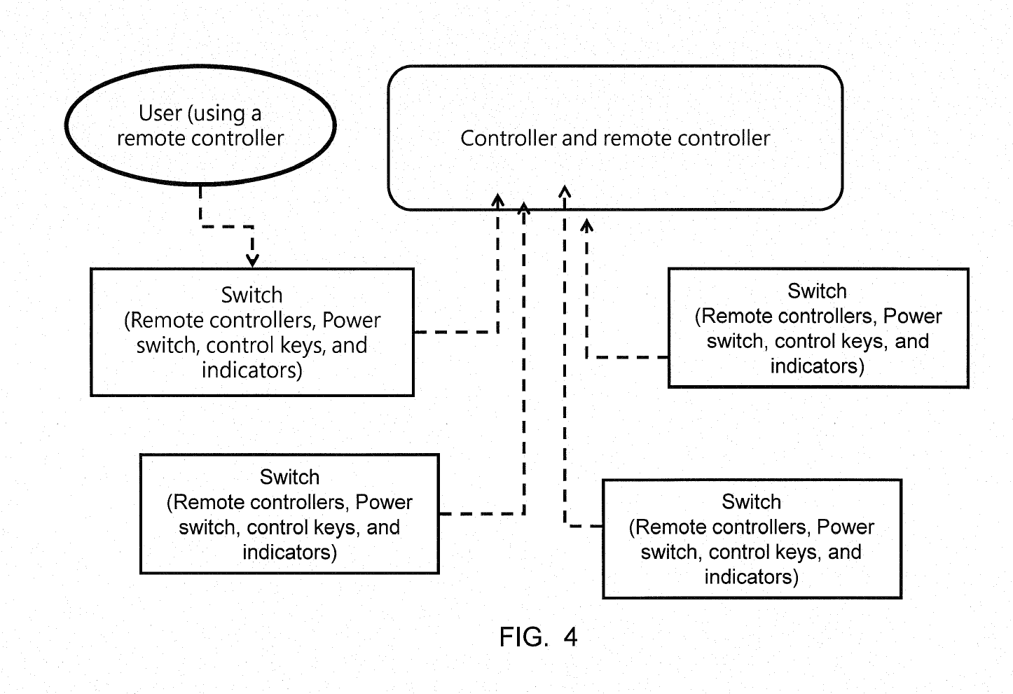

Referring to FIGS. 1, 2, 3 and 4, the multi-protocol switching control system is suitable for different kinds of central controller 10, which is preferably a wireless router. Furthermore, in the following, the lamp is used as an example, but in the present invention, other electric or electronic device is also suitable and is also within the scope of the present invention. The multi-protocol switching control system of the present invention includes the following elements.

A central controller 10 (preferably, a wireless router) serves to control at least one switch set by wired connection or wireless connection. The switch set is further connected to at least one lamp (or at least one electric or electronic device) Basically, the central controller 10 is a preferably a router with functions of signal transmitting and receiving. Furthermore, in the present invention, the central controller is suitable for variable communication protocols, such as Wi-Fi, Zigbee, Wireless WAN, LAN, 3G, 3.5G, 2G, etc. In the present invention, the central controller 10 is one of a wireless router a wireless node controller, a wireless network hub, a wireless IP hub, and a network recorder, and other wireless signal controllers.

At least one switch set 20 includes one or a plurality of switches 21. Each switch 21 serves to control the on and off operation of a lamp connected thereto. Each switch 21 can be built with a variable resistor for adjusting illumination of each lamp. The switch set 20 receives the control signal from the central controller 10 for turning on or off the lamp connected to the switch 21 and adjusting the illumination of the lamp.

The central controller 10 includes the following elements.

A central processor 11 serves for performing default instructions for instructing the switch sets 20 connected thereto.

At least one central memory 12 serves as a memory of the whole system.

A central transceiver 13 serves for wirelessly connecting other devices.

The central transceiver 13 includes the following elements.
A network transceiver 131 is connected to other network so that the central controller 10 of the present invention is wirelessly connected to the network through the network transceiver 131 for data transmission. Therefore, the central controller 10 of the present invention can be connected to handsets, computers, mobile phones, desktop computers, notebook computers, tablet computers, webpages of websites, multimedia devices, remoter controllers, and others.
A switch transceiver 132 serves to wirelessly connect with the following switch set 20.
A remoter controller transceiver 132 serves to wirelessly connect to other connected remoter controller 100.
A handset transceiver 134 serves to wirelessly connect with other handset 200.
Above mentioned wirelessly transceivers are built in one circuit or in different circuit. All these are within the scope of the present invention.

Other than above mentioned wirelessly transceivers, the present invention can be connected to other device by wired connection, and especially, to be connected to a network 300 or a computer 400 by wired connections.

By above mentioned connections, the central controller 10 can receive the instructions from remote controllers, computers, handsets or networks.

An I/O unit 135 serves as an input or output devices of the central controller 11 for connecting external I/O devices or displays (not shown).

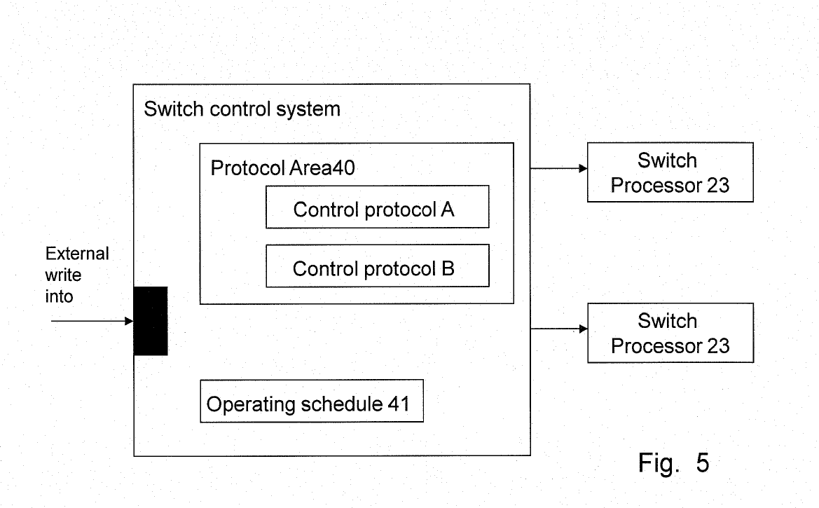

Referring to FIG. 5, the central controller 10 forms a switch protocol control unit which is defined in the central processor 11 and the central memory 12. The switch protocol control unit includes the following elements.

A protocol area 40 is defined in the central memory 12 by using a firmware. The protocol area 40 includes at least two control protocols 30. In this example, the control protocols 30 are lamp control protocols.

The switch control unit defines a protocol assign function to the protocol area 40. The function causes that one can define or input a protocol to the protocol area 40 and assigns the protocol as an operating protocol of the whole system. Thereby, the system of the present invention can receive external instructions and instruct the switch sets 21 connected to the central controller 11 to perfume operations.

The lamp control protocol 30 stored in the protocol area 40 may be original built in the protocol area 40 or be inputted externally. Generally, lamps from different manufacturers have different dedicated protocols. The system of the present invention can be installed with many different lamp control protocols 30 to fit lamps from different manufacturers.

The system of the present invention includes a lamp operating schedule 41. The lamp operating schedule 41 records the turning-on and -off schedules for at least one lamp controlled by the switch set 21. Thus, the switching of each lamp can be controlled by the lamp operating schedule 41. The timing of the lamps in the system can be centrally controlled by the central controller 10. It is unnecessary to further install timers to the lamps. The timing for turning on and off of the lamps may be originally set in the lamp operating schedule 41 or inputted by managers of the system as desired.

The switch set 20 includes following elements.
A switch memory 22 stores the lamp control protocols 30 of various lamps with respect to the lamp control protocols 30 in the central controller 10.
A switch processor 23 serves to perform instructions based on an assigned lamp control protocol 30 so that the switch set 20 can respond the instruction signals from the central controller 10 and instruct the lamps connected to the switch set 20 to operate.
At least one key 24 are included. The key 24 serves to control the turn on and off of each lamp. Each key is connected to the switch processor 23. The signals from the keys will be transferred to the switch processor 23 and then the switch processor 23 instructs the switch sets 20 to perform the action instructed by the key.
A switch receiver 24 serves to receive the instructions from the central controller 10 and then transfers the instructions to the switch processor 23.

At least one indication light 26 is connected to the switch processor 23 and a power source 28 for displaying the on and off state of the switch. Preferably, the indication light 26 is LED lights.

Moreover, since the central controller 10 could receiver input signals from a handset 100 so that various settings can be performed directly on the handset (or IPAD, IPHONE) so as to perform the convenience.

Other than the lamp control protocol 30, other non-lamp control protocol can be built in the central controller 10 and the switch set 20. Therefore the switch set 20 can be used to instruct devices assigned by the non-lamp control protocol.

Advantages of the present invention are that the central controller 10 of the present invention could be built with various lamp control protocols so as to fit different lamps or different electronic devices of different manufacturers. Thus if a user desires to built the system of the present invention, he (or she) does not need to update the switch sets or the lamps (or electronic devices) connected to the switch sets. Furthermore, if the control protocol for controlling the device to be used is not originally built in the system, the control protocol can be downloaded through networks or other input device for suiting the electronic devices connected to the switch set. The operation is easy and convenient. Moreover, the present invention provides many different control interfaces, such as keys, computers, remote controllers, handsets, or far ends controller through networks, etc. The lamp operating schedule in the central controller can centrally control the devices automatically.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-protocol switching control system suitable for controlling different electronic devices of different protocols by using a router capable of receiving different kinds of protocol to instruct switch sets connected thereto, the control system comprising:
a wireless router for controlling at least one switch set connected thereto by wired ways or wirelessly; the wireless router including a central controller and the central memory;
the at least one switch set having one or more switches; the switch set receiving control signals from the central controller for turning on or off electronic devices connected thereto;
wherein a protocol area is defined in the central memory by using a form of a firmware; the protocol area includes at least two control protocols;
the switch control unit defines a protocol assign function to the protocol area; the function causes that one can define or input a protocol to the protocol area and assign the protocol as an operating protocol of the whole system so that the operation protocols in the wireless routers are matched to those used in the switch sets; thereby, the system can receive external instructions and instruct the switch sets connected to the central controller to perfume predetermined operations.

2. The multi-protocol switching control system as claimed in claim 1, wherein the central processor serves to perform instructions based on the operating protocol for instructing the switch sets to further operate the device connected to the switch set.

2. The multi-protocol switching control system as claimed in claim 1, wherein the router further comprising:
a central transceiver for wirelessly connecting other devices; and
an I/O unit as an input or output devices of the central controller for connecting external I/O devices or displays; software or firmware within the router is changeable through the I/O unit or a network connected to the central controller.

3. The multi-protocol switching control system as claimed in claim 2, wherein the central transceiver further comprising:
a network transceiver connected to other network so that the central controller is wirelessly connected to the network for data transmission; and
a switch transceiver for wirelessly connecting with at least one switch set connected thereto.

4. The multi-protocol switching control system as claimed in claim 3, wherein the central controller is connected to a network so that far end control to the central controller is performable through the network.

5. The multi-protocol switching control system as claimed in claim 4, wherein the central controller is connected to one of handsets, computers, notebook computers, desktop computers, tablet computers, handsets, multi-media devices, webpages of networks, and remote controllers.

6. The multi-protocol switching control system as claimed in claim 1, wherein the central transceiver further comprises:
a remote transceiver for receiving and transmitting signals from a remoter controller; and
a handset transceiver for receiving and transmitting signals from a handsets.

7. The multi-protocol switching control system as claimed in claim 1, further comprising:
a lamp operating schedule for recording turning-on and turning-off schedules for at least one lamp controlled by the switch set; switching of each lamp being controllable by the lamp operating schedule; the operating timing of the device connected to the switch set being centrally controlled by the central controller.

8. The multi-protocol switching control system as claimed in claim 1, wherein the switch set includes
a switch memory storing the control protocols of the devices connected thereto; the control protocol stored in the switch memory is corresponding to the control protocols in the central controller;
a switch processor for instructing the switch set to respond the instruction signals from the central controller; and
a switch receiver for receiving the instructions from the central controller and then transferring the instructions to the switch processor.

9. The multi-protocol switching control system as claimed in claim further comprising:
at least one key for controlling turn on and off operation of each device connected to the switch set.

10. The multi-protocol switching control system as claimed in claim further comprising:
at least one indicating lamp for displaying on and off state of the switch in the switch set.

11. The multi-protocol switching control system as claimed in claim 1, wherein the device connected to the switch set is a lamp.

12. The multi-protocol switching control system as claimed in claim wherein the protocol is externally written into the protocol area.

13. The multi-protocol switching control system as claimed in claim 1, wherein the protocol is originally built in the protocol area.
